(19) United States
(12) Patent Application Publication
(10) Pub. No.: US 2020/0231853 A1
(43) Pub. Date: Jul. 23, 2020

(54) COMPOSITION OF REFRIGERANT FLUID, USE OF THE COMPOSITION, REFRIGERATING APPLIANCE, PACKED PRODUCT AND PACKAGING PROCESS

(71) Applicant: IDEAL INTELIGÊNCIA ENERGÉTICA LTDA., São Paulo-SP (BR)

(72) Inventor: Flávio Azzi Pacheco BORBA, São Paulo-SP (BR)

(21) Appl. No.: 16/639,142

(22) PCT Filed: Aug. 9, 2018
(86) PCT No.: PCT/BR2018/050283

§ 371 Date: Feb. 14, 2020

(30) Foreign Application Priority Data
Aug. 16, 2017 (BR) 102017017568.5

(51) Int. Cl. C09K 5/04; B65B 3/28

(52) U.S. Cl. CPC C09K 5/045; B65B 3/28; C09K 2205/126; C09K 2205/122; C09K 2205/22

(57) ABSTRACT

A composition of refrigerant fluid, which comprises the following components: a) at least one difluoromethane; b) at least one pentafluoroethane; c) at least one tetrafluoroethane; d) at least one tetrafluoropropene; and e) at least one trifluoroethane. The composition preferably further comprises nanoparticles selected from the group consisting of graphite, silver, zinc and silicon dioxide, and mixtures thereof.

### CROSS-REFERENCE TO RELATED APPLICATIONS

This application is a national stage application (under 35 U.S.C. § 371) of PCT/BR2018/050283, filed Aug. 9, 2018, which claims benefit of Brazilian Application No. 102017017568-5, filed Aug. 16, 2017, which are incorporated herein by reference in their entireties.

### FIELD OF THE INVENTION

The present invention relates to a composition of refrigerant fluid comprising a mixture of specific components, as well as its use in refrigerating appliances.

### BACKGROUND OF THE INVENTION

Are known from the state of the art numerous compositions of refrigerant fluids which typically comprise mixtures of refrigerant gases, applied to refrigerating appliances.

The choice of the specific components of these refrigerant gas mixtures can involve several technical factors, generally aligned in order to optimize the energy consumption and the environmental impact of the refrigeration device itself.

Refrigeration systems are responsible for a large part of the worldwide energy consumption, so any and all changes in refrigerant fluids that positively impact the energy consumption of the system as a whole, are highly desirable.

It is also desirable that refrigerant fluids have a low global warming potential (GWP), a parameter widely used to select refrigerant gases for commercial mixtures, and which explains the change from traditional chlorofluorocarbons (CFCs) and hydroclorofluorocarbons (HCFCs) to hydrofluorocarbons (HFCs) or hydrofluorolefins (HFOs), currently used.

In this sense, the document U.S. Pat. No. 8,038,899 describes refrigerant compositions that comprise mixtures of HFCs gases with siloxane solubilizing agents, seeking to improve the miscibility of the mixture provided. The mixtures disclosed in such document comprise up to three refrigerant gases.

In addition, U.S. Pat. No. 9,540,554 discloses refrigerant mixtures with three or four HFCs components and hydrofluorolefins (HFOs), in order to replace the state of the art mixtures that had high GWP values, and that can be used in various systems and refrigerating appliance.

Likewise, document U.S. Pat. No. 9,359,540 discloses compositions of refrigerant fluids containing up to three components, also looking for mixtures that have lower GWP values and better energy performance.

Thus, according to the information above, it is noted that the current state of the art continues to search for compositions of refrigerant fluid whose mixtures of specific components are capable of promoting an energy gain to the refrigerator, and which have low GWP values.

### BRIEF DESCRIPTION OF THE INVENTION

In a first aspect, the present invention refers to a composition of refrigerant fluid comprising the following components:

a) at least one difluoromethane;

b) at least one pentafluoroethane;

c) at least one tetrafluoroethane;

d) at least one tetrafluoropropene;

e) at least one trifluoroethane.

In a preferred embodiment, tetrafluoroethane is 1,1,1,2-tetrafluoroethane.

In another preferred embodiment, the tetrafluoropropene is 2,3,3,3-tetrafluoropropene.

In another preferred embodiment, the trifluoroethane is 1,1,1-trifluoroethane.

In another preferred embodiment, the components of the composition of refrigerant fluid have the following ratios:

a) from 20 to 30% by weight of difluoromethane, in relation to the total weight of the composition;

b) from 20 to 30% by weight of pentafluoroethane, in relation to the total weight of the composition;

c) from 15 to 25% by weight of tetrafluoroethane, in relation to the total weight of the composition;

d) from 15 to 25% by weight of tetrafluoropropene, in relation to the total weight of the composition;

e) from 5 to 15% by weight of trifluoroethane, in relation to the total weight of the composition.

In another preferred embodiment, the composition of refrigerant fluid further comprises nanoparticles, which preferably have a particle size ranging between 1 and 20 nm.

In another preferred embodiment, the nanoparticles are selected from the group consisting of graphite, silver, zinc and silicon dioxide, and mixtures thereof, preferably silicon dioxide.

In another preferred embodiment, the amount of nanoparticles is up to 5% by weight, in relation to the total weight of the composition.

The present invention also relates to the use of the composition, as defined above, in a refrigerating appliance.

Another object of the present invention is a refrigerating appliance comprising at least one heat exchanger, at least one compressor, and the composition of refrigerant fluid as defined above.

An additional object of the present invention is a packed product which comprises an external housing, which stores the composition of refrigerant fluid, as defined above.

Finally, another object of the present invention is a process for packing the composition of refrigerant fluid, as defined above, comprising the steps of:

a) transfer of components a) to e) in liquid phase to a watertight system;

b) weighing the composition; and

c) packing the composition.

### BRIEF DESCRIPTION OF THE FIGURES

FIGS. 1 to 7 disclose graphs of power consumed by the refrigerating appliances that use the composition of refrigerant fluid according to embodiments of the present invention, in comparison to other compositions of the prior art.

FIG. 8 shows a graph of energy and current consumption for refrigerating appliances using the composition of refrigerant fluid according to embodiments of the present invention, in comparison to other compositions of the prior art.

FIG. 9 shows a graph of insufflation temperature and external air variation for refrigerating appliance using the composition of refrigerant fluid according to embodiments of the present invention, in comparison to other compositions of the prior art.

### DETAILED DESCRIPTION OF EMBODIMENTS OF THE INVENTION

The present invention refers to a composition of refrigerant fluid that comprises a mixture of five components, described below:

a) at least one difluoromethane;

b) at least one pentafluoroethane;

c) at least one tetrafluoroethane;

d) at least one tetrafluoropropene; and

e) at least one trifluoroethane.

For difluoromethane, there is only one possibility of configuring fluorine atoms, detailed below in Formula (I):

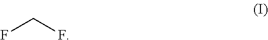

Difluoromethane is a refrigerant fluid known in the prior art, sold under the reference “R32a”, and CAS number: 75-10-5.

Likewise, for pentafluoroethane, there is also only one possibility of configuring fluorine atoms, detailed below in Formula (II):

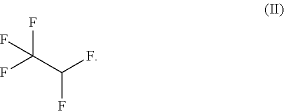

Pentafluoroethane is a refrigerant fluid known in the prior art, sold under the reference “R125a”, and CAS number: 354-33-6.

For tetrafluoroethane, more than one configuration is possible, with 1,1,1,2-tetrafluoroethane being preferred, detailed below in formula (III):

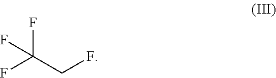

Tetrafluoroethane is a refrigerant fluid known in the prior art, sold under the reference “R134a”, and CAS number: 811-97-2.

Tetrafluoropropene also has more than one possible configuration, with 2,3,3,3-tetrafluoropropene being preferred, whose structure is detailed below in Formula (IV):

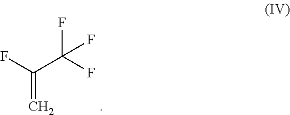

Tetrafluoropropene is a refrigerant fluid known in the prior art, sold under the reference “HF01234yf”, and CAS number: 754-12-1.

Finally, the preferred trifluoroethane is 1,1,1-trifluoroethane, the structure of which is detailed in Formula (V) below:

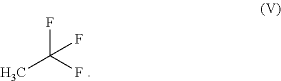

Trifluoroethane is a refrigerant fluid known in the prior art, sold under the reference “R143a”, and CAS number: 420-46-2.

All five components of the mixture must be present so that the best energy performance and the lowest GWP values are obtained, according to the present invention.

Preferably, the components of the composition of refrigerant fluid are present in the following ratios:

a) from 20 to 30% by weight of difluoromethane, in relation to the total weight of the composition;

b) from 20 to 30% by weight of pentafluoroethane, in relation to the total weight of the composition;

c) from 15 to 25% by weight of tetrafluoroethane, in relation to the total weight of the composition;

d) from 15 to 25% by weight of tetrafluoropropene, in relation to the total weight of the composition;

e) from 5 to 15% by weight of trifluoroethane, in relation to the total weight of the composition.

Importantly, the ratio between the components of the present invention is not easily derived from the state of the art. In particular, the concentration of 15 to 25% tetrafluoroethane escapes from the commonly used, since such component is usually used in a base ratio, i.e., at higher concentrations.

The choice of each of the five components of the composition of the present invention also involved extensive planning. The presence of trifluoroethane, for example, implies optimization of the “glide” value, which refers to the variation between the superheat and supercooling temperatures.

The composition of refrigerant fluids of the present invention have potential destruction of the ozone layer (ODP) equal to zero, and low GWP values compared to compositions known in the art.

The composition of refrigerant fluids of the present invention has a lower nominal working pressure, which generates an expressive thermal and energy gain, creating relief for the refrigeration system as a whole.

In addition, the composition of refrigerant fluids of the present invention can be used with any type of lubricating oil and, increasing its versatility and allowing its application in different refrigerating appliances.

In particular, the compositions of the present invention can be applied in the area of refrigeration, air-conditioning, and heating with heat exchangers. More specifically, it is possible to implement in air-conditioning equipment of all models, automotive air-conditioning, fridges, cold rooms, refrigerated counters, refrigerated and cooling equipment of all types, pool heaters, heaters in general with heat exchanger fluids.

The composition of refrigerant fluid of the present invention provides an energy efficiency gain to the refrigerating appliances.

In a preferred embodiment, the composition of refrigerant fluid further comprises nanoparticles, which preferably have a particle size ranging between 1 and 20 nm.

The nanoparticles are preferentially dispersed in the mixture of the refrigerant base fluid, acting in the reduction of the friction of the surface of the pipe of the refrigerating appliance and of the compressor. In this sense, it is possible to decrease the oil temperature and, mainly, the temperature of the compressor crankcase, providing efficiency gains and gains with the reduction in energy consumption of the refrigerating appliance, as a result of the increase in thermodynamic performance as a whole.

Still, common refrigerant fluids do not have lubricating properties, bringing greater wear to the refrigerating appliances and compressors, with excessive wear to the equipment as a whole, which reduces its life-span.

Thus, the presence of nanoparticles in the composition of refrigerant fluid of the present invention provides significant gain savings in total energy consumption and consumed power by the refrigerating appliance with increased performance and thermal efficiency of the implemented equipment. In addition, it increases the life-span of the lubricating oil and, consequently, of the compressor of the refrigerating appliance.

As noted above, the nanoparticles provide a considerable decrease in friction caused by the grooves of the pipe of the refrigerating appliance. The nanoparticles fill the said grooves, decreasing almost 100% the coefficient of friction between the refrigerant fluid and the surface of the pipes of the refrigerating appliance, as well as the very contact surface with the compressor head, forming a protective film consequently increasing the lubrication. It decreases the working temperature of the refrigerating appliance and improves the energy efficiency of the equipment as a whole.

The presence of nanoparticles also causes an increase in the thermal conductivity of the refrigerant fluid, increasing the temperature gain when reaching the set-point in a faster and more efficient way, which can generate gains and reduce the consumption of refrigerating appliances, on average, with 30% economy.

Since the composition of refrigerant fluid of the present invention comprises a mixture of refrigerant gases (“blend”), the nanoparticles have another important role in the stability of the composition, preventing the mixtures from separating in several phases.

In a preferred manner, the nanoparticles are selected from the group consisting of graphite, silver, zinc and silicon dioxide, and mixtures thereof, being most preferably of silicon dioxide.

In a preferred embodiment, the nanoparticles are present in small amounts, particularly up to 5% by weight, in relation to the total weight of the composition. In a preferred embodiment, the amount of nanoparticles ranges from 0.1 to 5% by weight.

The present invention also relates to the use of the composition, as defined above, in a refrigerating appliance, as well as to a refrigerating appliance itself, which comprises at least one heat exchanger, at least one compressor, and the composition of refrigerant fluid, as defined above.

As noted above, a refrigerating appliance means air-conditioning equipment of all models, automotive air-conditioning, fridges, cold rooms, refrigerated counters, refrigerated and cooling equipment of all types, pool heaters, heaters in general with heat exchanger fluids.

Yet another object of the present invention is a packed product that comprises an external housing, which stores the composition of refrigerant fluid, as defined above.

The composition of refrigerant fluid can be packed via liquid transfer in a sealed system, via vacuum pump and suction compressors, weighing and packing of the composition. In a particularly preferred embodiment, the composition of refrigerant fluid is packed together with the nanoparticles, allowing its easy application to different refrigerating appliances.

### EXAMPLES

It was carried out thermodynamic performance analysis of the composition of refrigerant fluid of the present invention, particularly with additive of dioxide silicon nanoparticles in refrigeration and air-conditioning systems which use compressors and refrigerant fluids.

It was verified the influence of the new formulation of efficient refrigerant fluid having the related composition of the components, along with the silicon dioxide nanoparticles with colloidal kinetic stability on the performance of refrigeration and air-conditioning systems.

Temperature lowering and cycling tests were carried out according to NBR12866 and NBR12869 standards, respectively, to obtain the results of increased performance in refrigeration and air-conditioning systems as a whole, with a significant gain in the following operational parameters:
Number of cycles/delta-t/per hour;
Pressures of suction and discharge;
Percentage of operation time of the equipment the quantity of actuation;
Temperature of the compressor crankcase;
Evaporation/insufflation temperature;
Condensing temperature;
Thermal conductivity /k/ in the heat exchangers;
Energy consumption until temperature set-point;
Total energy consumption and power consumed;
Lubrication, miscibility and viscosity of the lubricant oil with the refrigerant fluid.

It was also verified an increase in thermal conductivity with a decrease in friction caused between the copper pipe wall and the refrigerant fluid, and a decrease in friction in the compressor head wall, with improved lubrication characteristics and oil viscosity due to the increase of the fraction by mass of nanoparticle in the base refrigerant fluid.

The composition of refrigerant fluid proved to be miscible with all types of lubricant oils existing on the market, including the mineral oil, polyester/POE/and alquibenzene oil synthetic oil.

In addition, it was verified a significant gain in thermodynamic performance in the condensing temperature, with a gain of around 25.9% in thermal efficiency compared to other conventional fluids on the market.

Due to the low pressure characteristic of suction and discharge, the composition of the fluid refrigerant was considered safe for use as a direct replacement/“drop-in”/of any common refrigerant fluid existing on the market, since the manufacture condition of refrigeration and air-conditioning equipment is prepared for nominal working conditions with higher pressures. Normally, it is guaranteed by the equipment manufacturers using the common gases, such as R22/R134a/R407/R404, maximum pressure of up to 400 psi and, for R410, maximum pressure of up to 700 psi. In all cases, they are much higher pressures than the pressures used by the new composition of refrigerant fluid of the present invention, which does not exceed the conditions of low 60 psi and high 240 psi.

The relief of the refrigerant system as a whole, due to the parameters and thermal variables gain as a result of the reductions in friction, the significant increase in thermal conductivity /K/, the decrease of the pressure in suction and discharge, generates a significant increase of life-span for the equipment where the new formulation of high-performance refrigerant fluid was implemented, especially with nanoparticle additives, and its use in refrigeration and air-conditioning systems is considered safer, compared to common refrigerant fluids on the market.

### Example 1

The composition of refrigerant fluid of the present invention (difluoromethane, pentafluoroethane, tetrafluoroethane, tetrafluoropropene and trifluoroethane) was tested in comparison with a known composition of the state of the art of chlorodifluoromethane—CHCIF₂ (fluid R 22), in an LG 12,000 Btu/h refrigerating appliance.

The data obtained are compiled in the tables below:

| | |
|---|---|
| Fluid R 22 | Invention |

| | | | | |
|---|---|---|---|---|
| Pressure | | | | |
| Suction | 60 | PSI | 45 | PSI |
| Temperature | | | | |
| Air insufflation | 08.6° | C. | 01° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 220 | 220 | | 220 | 220 | |
| Current (A) | 5.2 | 5.2 | | 3.6 | 3.6 | |
| Power (W) | 1144 | 1114 | 0 | 792 | 726 | 0 |

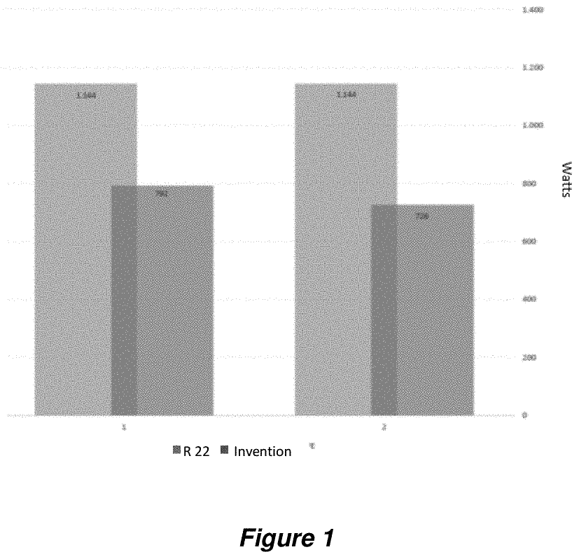

The graph of FIG. 1 demonstrates the decrease in power obtained with the composition of refrigerant fluid according to the present invention.

### Example 2

The composition of refrigerant fluid of the present invention was tested in comparison with a composition known in the art (fluid R 22) in a Springer 9000 Btu/hr refrigerating appliance.

The data obtained are compiled in the tables below:

| | |
|---|---|
| Fluid R 22 | Invention |

| | | | | |
|---|---|---|---|---|
| Pressure | | | | |
| Suction | 65 | PSI | 45 | PSI |
| Temperature | | | | |
| Air insufflation | 12° | C. | 06.4° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 220 | 220 | | 220 | 220 | |
| Current (A) | 3.89 | 3.89 | | 2.5 | 2.7 | |
| Power (W) | 855.8 | 856 | 0 | 550 | 594 | 0 |

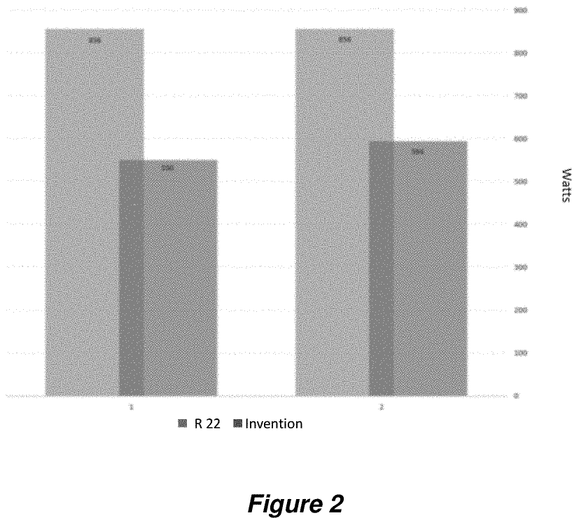

The graph of FIG. 2 shows the decrease in power obtained with the composition of refrigerant fluid according to the present invention.

### Example 3

The composition of refrigerant fluid of the present invention was tested in comparison with a composition known in the art (fluid 22) in a Midea 30,000 Btu refrigerating appliance.

The data obtained are compiled in the tables below:

| | |
|---|---|
| Fluid R 22 | Invention |

| | | | | |
|---|---|---|---|---|
| Pressure | | | | |
| Suction | 50 | PSI | 50 | PSI |
| Discharge | 250 | PSI | 120 | PSI |
| Temperature | | | | |
| Air return | 20.5° | C. | 19° | C. |
| Air insufflation | 7° | C. | 3.3° | C. |
| Suction temperature | 13° | C. | 7° | C. |
| Discharge temperature | 19° | C. | 17° | C. |
| Crankcase temperature | 55° | C. | 33° | C. |
| Room temperature | 20° | C. | 19° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 220 | 220 | | 220 | 220 | |
| Current (A) | 10.8 | 11 | | 7.5 | 7.7 | |
| Power (W) | 2,376 | 2,420 | | 1,650 | 1,694 | |

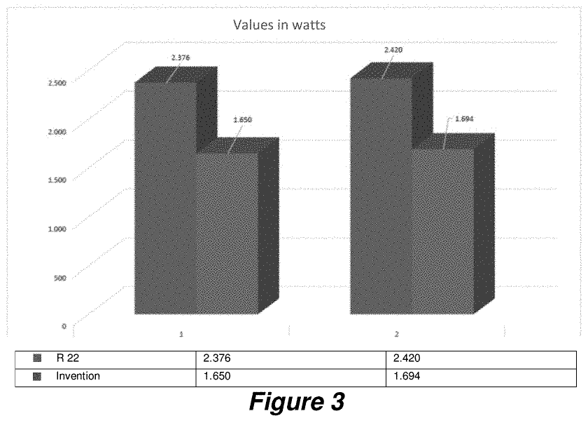

The graph of FIG. 3 shows the decrease in power obtained with the composition of refrigerant fluid according to the present invention.

### Example 4

The composition of refrigerant fluid of the present invention was tested in comparison with a composition known in the art (fluid R 22), in a 9,000 Btu Split Carrier refrigerating appliance.

The data obtained are compiled in the tables below:

| | |
|---|---|
| Fluid R 22 | Invention |

| | | | | |
|---|---|---|---|---|
| Pressure | | | | |
| Suction | 60 | PSI | 50 | PSI |
| Discharge | 260 | PSI | 120 | PSI |
| Temperature | | | | |
| Air return | 23.5° | C. | 21.5° | C. |
| Air insufflation | 13° | C. | 3.3° | C. |
| Suction temperature | 14° | C. | 5° | C. |
| Discharge temperature | 23° | C. | 16° | C. |
| Crankcase temperature | 38° | C. | 27° | C. |
| Room temperature | 23° | C. | 22.5° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 220 | 220 | | 220 | 220 | |
| Current (A) | 5.8 | 6 | | 3.5 | 3.2 | |
| Power (W) | 1,276 | 1,320 | | 770 | 704 | |

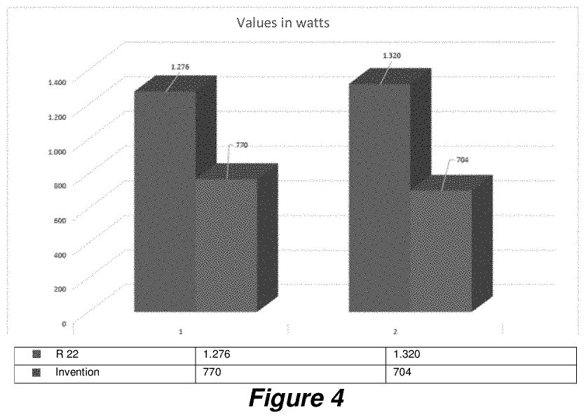

The graph of FIG. 4 demonstrates the decrease in power obtained with the composition of refrigerant fluid according to the present invention.

### Example 5

The composition of refrigerant fluid of the present invention was tested in comparison with a composition known in the art (fluid R 22) in a Springer Carrier 90,000 Btu refrigerating appliance.

The data obtained are compiled in the tables below:

| | |
|---|---|
| Fluid R 22 | Invention |

| | | | | |
|---|---|---|---|---|
| Pressure | | | | |
| Suction | 60 | PSI | 50 | PSI |
| Discharge | 290 | PSI | 125 | PSI |
| Temperature | | | | |
| Air return | 23.1° | C. | 22.9° | C. |
| Air insufflation | 8.2° | C. | 4.5° | C. |
| Suction temperature | 11° | C. | 6.5° | C. |
| Discharge temperature | 32.1° | C. | 27° | C. |
| Crankcase temperature | 42.5° | C. | 33° | C. |
| Room temperature | 22.9° | C. | 22.8° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 218 | 218 | 218 | 218 | 218 | 218 |
| Current (A) | 16.1 | 15.2 | 16.4 | 13.8 | 14.5 | 13.7 |
| Power (W) | 3,510 | 3,314 | 3,575 | 3,008 | 3,161 | 2,987 |

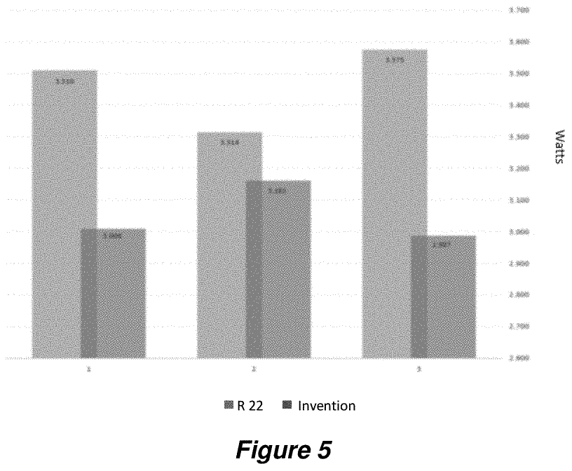

The graph of FIG. 5 shows the decrease in power obtained with the composition of refrigerant fluid according to the present invention.

### Example 6

The composition of refrigerant fluid of the present invention was tested in comparison with a composition known in the art (fluid R 22), in a Springer Carrier 30 TR refrigerating appliance.

The data obtained are compiled in the tables below:

| | |
|---|---|
| Fluid R 22 | Invention |

| | | | | |
|---|---|---|---|---|
| Pressure | | | | |
| Suction | 55 | PSI | 50 | PSI |
| Discharge | 265 | PSI | 135 | PSI |
| Temperature | | | | |
| Air return | 22.8° | C. | 22.5° | C. |
| Air insufflation | 12.5° | C. | 3.5° | C. |
| Suction temperature | 11° | C. | 5.5° | C. |
| Discharge temperature | 31° | C. | 19° | C. |
| Crankcase temperature | 83° | C. | 54° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 217 | 217 | 217 | 217 | 217 | 217 |
| Current (A) | 48.3 | 48.5 | 48.7 | 20.4 | 20.3 | 20.6 |
| Power (W) | 10,481 | 10,525 | 10,568 | 4,427 | 4,405 | 4,470 |

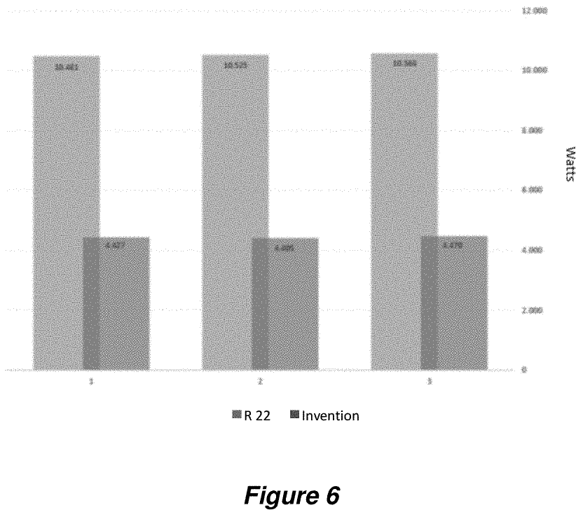

The graph of FIG. 6 shows the decrease in power obtained with the composition of refrigerant fluid according to the present invention.

### Example 7

The composition of refrigerant fluid of the present invention was tested in comparison with a composition known in the art (fluid R 22), in a Hitachi 50,000 Btu refrigerating appliance.

The data obtained are compiled in the tables below:

| | |
|---|---|
| Fluid R 22 | Invention |

| | | | | |
|---|---|---|---|---|
| Pressure | | | | |
| Suction | 60 | PSI | 50 | PSI |
| Discharge | 260 | PSI | 130 | PSI |
| Temperature | | | | |
| Air return | 24° | C. | 21° | C. |
| Air insufflation | 14.5° | C. | 3.4° | C. |
| Suction temperature | 22° | C. | 7.3° | C. |
| Discharge temperature | 39° | C. | 18° | C. |
| Crankcase temperature | 68° | C. | 33° | C. |
| Room temperature | 22° | C. | 19° | C. |

| Current | Fluid R 22 | | | Invention | | |
|---|---|---|---|---|---|---|
| Measure- | Phase | Phase | Phase | Phase | Phase | Phase |
| ments | 1 | 2 | 3 | 1 | 2 | 3 |
| Voltage (V) | 220 | 220 | 220 | 220 | 220 | 220 |
| Current (A) | 18.5 | 18.1 | 18.1 | 9.6 | 10.1 | 10.4 |
| Power (W) | 4,070 | 3,982 | 3,982 | 2,112 | 2,222 | 2,288 |

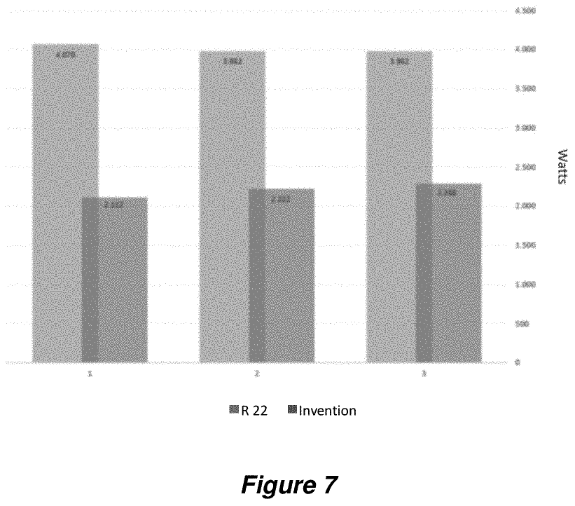

The graph of FIG. 7 shows the decrease in power obtained with the composition of refrigerant fluid according to the present invention.

### Example 8

The technology company IMG Energia e Sustentabilidade also carried out comparative tests between the composition of refrigerant fluid of the present invention, and a composition known in the art of tetrafluoroethane C₂H₂F₄ (fluid R 134).

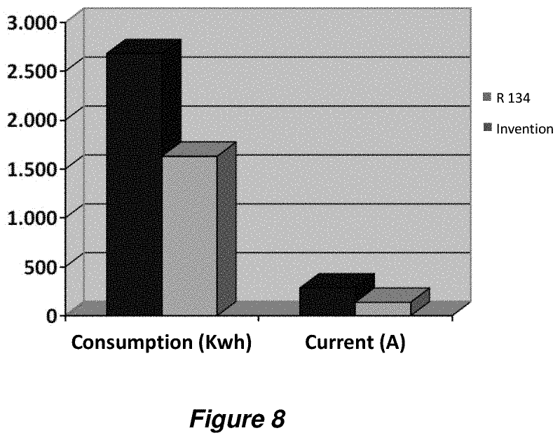

The results of reduced consumption (60.8% reduction) and lower current (48.2% reduction) for the composition of the present invention are summarized in the graph of FIG. 8.

### Example 9

The composition of refrigerant fluid of the present invention was tested in comparison with a composition known in the art of a mixture of difluoromethane—CH₂F₂—and pentafluoroethane—CHF₂CF₃—(fluid R 410A), in two machines of 10 TR each manufactured by Hitachi.

The refrigerant fluid of the present invention was placed in a machine in place of the R410A and the Global driver was also installed in the compressor to compare the electric energy consumption of the two machines.

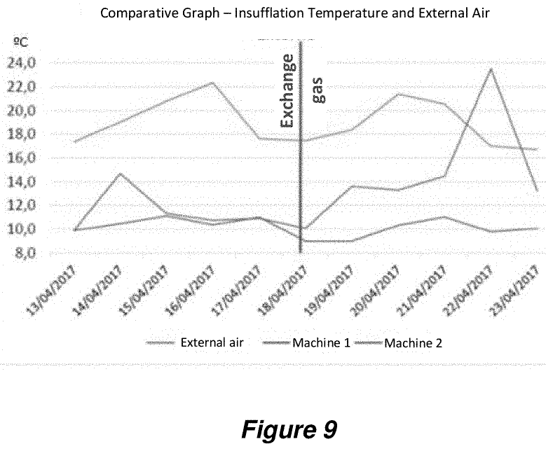

The results of lower insufflation temperature (reduction of 0.7° C.) are summarized in the graph of FIG. 9.

In addition, there was a 42% reduction in consumption after fluid exchange (488 kWh with the fluid R 410 A and 285 kWh with the fluid of the present invention).

There is a gain through the lower insufflation temperature, with the use of the compositions of refrigerant fluid of the present invention, instead of the compositions known from the state of the art, in addition to pressure relief in almost all cases (mainly at low pressures and suction).

As well understood by those skilled in the art, numerous modifications and variations of the present invention are possible in the light of the above teachings, without departing from its scope of protection, as defined by the appended claims.

1. A composition for refrigerant fluid comprising:
(a) from 20 to 30% by weight of at least one difluoromethane, in relation to the total weight of the composition;
(b) from 20 to 30%, by weight, of at least one pentafluoroethane, in relation to the total weight of the composition;
(c) from 15 to 25% by weight of at least one tetrafluoroethane, in relation to the total weight of the composition;
(d) from 15 to 25% by weight of at least one tetrafluoropropene, in relation to the total weight of the composition; and
(e) from 5 to 15% by weight of at least one trifluoroethane, in relation to the total weight of the composition.

2. The composition according to claim 1, wherein the tetrafluoroethane is 1,1,1,2-tetrafluoroethane.

3. The composition according to claim 1, wherein the tetrafluoropropene is 2,3,3,3-tetrafluoropropene.

4. The composition according to claim 1, wherein the trifluoroethane is 1,1,1-trifluoroethane.

5. The composition according to claim 1 further comprising nanoparticles.

6. The composition according to claim 5, wherein the nanoparticles have a particle size that varies between 1 and 20 nm.

7. The composition according to claim 5, wherein the nanoparticles are selected from graphite, silver, zinc and silicon dioxide, and mixtures thereof.

8. The composition according to claim 5, wherein the nanoparticles are of silicon dioxide.

9. The composition according to claim 5, wherein the amount of nanoparticles is up to 5% by weight, in relation to the total weight of the composition.

10. (canceled)

11. A refrigerant appliance comprising:
(a) at least one heat exchanger,
(b) at least one compressor, and
(c) the composition for refrigerant fluid of claim 1.

12. A product comprising:
(a) the composition for refrigerant fluid of claim 1; and
(b) an external housing configured to store the composition for refrigerant fluid.

13. A method for packaging the composition for refrigerant fluid of claim 1 comprising:
(i) transferring components (a) to (e) in liquid phase to a watertight system;
(ii) forming the composition for refrigerant fluid of claim 1 from the components (a) to (e);
(iii) weighing the composition; and
(iv) packing the composition.

14. A method of using a composition for refrigerant fluid comprising:
(a) providing the composition for a refrigerant of claim 1; and
(b) introducing the composition for a refrigerant into a refrigerating appliance.

15. The method according to claim 14, wherein the tetrafluoroethane of the composition for a refrigerant is 1,1,1,2-tetrafluoroethane.

16. The method according to claim 14, wherein the tetrafluoropropene of the composition for a refrigerant is 2,3,3,3-tetrafluoropropene.

17. The method according to claim 14, wherein the trifluoroethane of the composition for a refrigerant is 1,1,1-trifluoroethane.

18. The method according to claim 14, wherein the composition for a refrigerant further comprises nanoparticles.

19. The refrigerating appliance according to claim 11, wherein the tetrafluoroethane of the composition for a refrigerant is 1,1,1,2-tetrafluoroethane.

20. The refrigerating appliance according to claim 11, wherein the tetrafluoropropene of the composition for a refrigerant is 2,3,3,3-tetrafluoropropene.

21. The refrigerating appliance according to claim 11, wherein the trifluoroethane of the composition for a refrigerant is 1,1,1-trifluoroethane.
